(19) United States
(12) Patent Application Publication
(10) Pub. No.: US 2026/0266409 A1
(43) Pub. Date: Sep. 10, 2026

(54) PIPE FOR THE TRANSFER OF CRYOGENIC FLUID

(71) Applicant: L'Air Liquide, Société Anonyme Pour I'Etude et I'Exploitation des Procédés Georges Claude, Paris (FR)

(72) Inventors: Guillaume BOYE, Voiron (FR); Phillippe CADEAU, Lans en Vercors (FR); Stephane DUVAL, Saint Appolinard (FR)

(21) Appl. No.: 19/167,712

(22) PCT Filed: Mar. 14, 2024
(86) PCT No.: PCT/EP2024/056868

§ 371 Date: Sep. 22, 2025

(30) Foreign Application Priority Data
Apr. 4, 2023 (FR) FR2303322

(51) Int. Cl. F16L 51/02; F16L 9/18; F16L 59/065; F16L 59/14

(52) U.S. Cl. CPC F16L 51/025; F16L 9/18; F16L 59/065; F16L 59/141

(57) ABSTRACT

A double-jacket pipe for transferring cryogenic fluid, including an outer jacket and at least one inner line configured to transfer the cryogenic fluid, the inner line extending inside the outer jacket, the outer jacket and the inner line together defining an internal annular space configured to be evacuated, the pipe including a first section including a first thermal barrier connected at a first end to the outer jacket and at a second end to the inner line, the first thermal barrier extending inside the internal space. Wherein the first thermal barrier includes a first thermal compensator configured to compensate for the thermal expansion/contraction of the inner line relative to the outer jacket, the inner line including a thermal line compensator arranged on the wall of the inner line.

### CROSS REFERENCE TO RELATED APPLICATIONS

This application is a 371 of International Application No PCT/EP 2024/056868, filed Mar. 14, 2024, which claims priority to French Patent Application No, FR 2303322, filed Apr. 4, 2023, the entire contents of which are incorporated herein by reference.

### BACKGROUND

The present invention relates to a pipe for the transfer of cryogenic fluid and a method for assembling such a pipe.

The invention relates more particularly to a double-jacket pipe for transferring cryogenic fluid, including an outer jacket and at least one inner line for transferring the cryogenic fluid, the inner line extending inside the outer jacket, the outer jacket and the inner line together defining an internal space, notably an annular space, intended to be evacuated, the pipe including a first section including a first thermal barrier connected at one of its ends to the outer jacket and at the other of its ends to the inner line, the first thermal barrier extending inside the internal space.

A double-jacket vacuum pipe is manufactured in the workshop in the form of a plurality of first sections prefabricated with a sealed vacuum, a first section being connected, on site, to the rest of the pipe via a connecting section.

A pipe of this type is subjected to phenomena of expansion and contraction of some of its components mainly because of the cold generated by the cryogenic fluid flowing in the inner line.

A known solution consists of using a thermal compensator formed on the connecting section, the thermal compensator being interposed between two thermal barriers.

This type of solution has the disadvantage of multiplying the number of thermal compensators in the inner line of the pipe, which poses a leak risk.

### SUMMARY

An objective of the present invention is to overcome some or all of the aforementioned drawbacks of the prior art.

The present invention, in accordance with the generic definition given in the preamble above, is characterized in that the first thermal barrier includes a first thermal compensator, notably configured to compensate for the thermal expansion/contraction of the inner line relative to the outer jacket, the inner line includes a thermal line compensator arranged on the wall of the inner line.

This makes it possible to absorb deformations in the piping without requiring a thermal compensator on the inner line of each section.

In addition, this prevents the thermal compensator from coming into contact with the cryogenic fluid. Such a thermal compensator is used to seal the sealed vacuum of the first section, while accompanying the movements related to thermal expansion or thermal contraction.

Finally, such a solution limits the pressure drops in the inner line of the pipe.

According to one embodiment, the pipe is rigid or semi-rigid.

According to one embodiment, the first thermal barrier extends between its two ends.

According to one embodiment, the first thermal barrier extends inside the internal space, to sealingly separate the internal space between a first portion of the internal space and a second portion of the internal space, each arranged on either side of the first thermal barrier.

According to one embodiment, the first thermal compensator includes a first elastic portion, for example a first elastic bellows.

According to one embodiment, the first elastic portion extends in the direction in which at least a portion of the first section extends.

According to one embodiment, the first elastic portion is configured to be extended or compressed in the direction of a first axis, the first axis extending in the direction in which at least the portion of the inner line facing the first elastic portion extends.

According to one embodiment, the first thermal compensator includes a fixed wall extending in the direction of the first axis, notably over a length at least equal to the length of the first elastic portion, the length being measured along the axis.

According to one embodiment, the inner line is configured to allow the cryogenic fluid to flow in the inner line without being in contact with the first thermal compensator.

According to one embodiment, the thermal line compensator is mounted freely relative to the outer jacket.

According to one embodiment, the thermal line compensator includes an elastic line bellows.

According to one embodiment, the first section includes a second thermal barrier extending inside the internal space.

According to one embodiment, the second thermal barrier is configured to sealingly separate the internal space.

According to one embodiment, the second thermal barrier is configured to separate the internal space between the first portion of the internal space and a fourth portion of the internal space, each arranged on either side of the second thermal barrier.

Alternatively, the second thermal barrier is configured to insulate the first portion of the internal space from the outside of the pipe.

According to one embodiment, the first thermal barrier and the second thermal barrier are configured to keep the first portion of the internal space under vacuum.

According to one embodiment, the second thermal barrier includes a second thermal compensator configured to compensate for the thermal expansion/contraction of the inner line relative to the outer jacket.

According to one embodiment, the second thermal compensator includes a second elastic portion, for example an elastic bellows.

According to one embodiment, the pipe includes a connecting section sealingly connected to the first section at one of the ends of the connecting section.

According to one embodiment, the connecting section includes an orifice intended to allow the pressure in the internal space to be reduced.

According to one embodiment, the orifice includes a hole passing through the outer jacket.

According to one embodiment, the connecting section is connected to the first section, near to the first thermal barrier.

According to one embodiment, the connecting section includes a pumping valve, notably arranged on the outer jacket.

According to one embodiment, the pumping valve is arranged to allow a connection with a vacuum pump to allow the pressure in the internal space to be reduced.

According to one embodiment, the connecting section is connected to the first section by welding.

According to one embodiment, the connecting section is configured such that its length varies only as a result of its own thermal expansion/contraction.

According to one embodiment, the connecting section does not have a thermal compensator to compensate for the thermal expansion/contraction of the inner line relative to the outer jacket.

According to one embodiment, the inner line of the connecting section forms a rigid tubular portion extending over at least half the length of the connecting section, notably over the entire length of the connecting section.

According to one embodiment, the pipe includes a third section sealingly connected to the connecting section at the other of the ends of the connecting section, the third section including a third thermal barrier connected at one of its ends to the outer jacket and at the other of its ends to the inner line, the third thermal barrier extending inside the internal space.

According to one embodiment, the third thermal barrier extends inside the internal space, between the two ends of the third thermal barrier.

According to one embodiment, the third thermal barrier extends inside the internal space, being configured to sealingly separate the internal space, between the second portion of the internal space and a third portion of the internal space, each arranged on either side of the third thermal barrier.

According to one embodiment, the third thermal barrier includes a third thermal compensator.

According to one embodiment, the third thermal compensator is configured to compensate for the thermal expansion/contraction of the inner line relative to the outer jacket.

According to one embodiment, the third thermal compensator includes a third elastic portion, for example a third elastic bellows.

According to one embodiment, the third section includes a fourth thermal barrier connected at one of its ends to the outer jacket and at the other of its ends to the inner line, the fourth thermal barrier extending inside the internal space.

According to one embodiment, the fourth thermal barrier is configured to sealingly separate the internal space between the third portion of the internal space and a fifth portion of the internal space, each arranged on either side of the fourth thermal barrier.

Alternatively, the fourth thermal barrier is configured to insulate the third portion of the internal space from the outside of the pipe.

According to one embodiment, the pipe includes a plurality of first sections and/or third sections and/or connecting sections.

The invention also relates to a method for assembling a double-jacket pipe for the transfer of cryogenic fluid, including the following steps:
providing an outer jacket and at least one inner line for transferring the cryogenic fluid, the inner line extending inside the outer jacket, the outer jacket and the inner line together defining an internal space, notably an annular space, intended to be evacuated, the pipe including a first section including a first thermal barrier connected at one of its ends to the outer jacket and at the other of its ends to the inner line, the first thermal barrier extending inside the internal space, the first thermal barrier includes a first thermal compensator, notably configured to compensate for the thermal expansion/contraction of the inner line relative to the outer jacket;
providing a connecting section including an orifice intended to allow the pressure in the internal space to be reduced;
sealingly connecting, notably by welding, one of the ends of the connecting section to one of the ends of the first section;
reducing the pressure in the internal space, notably by connecting the orifice to a vacuum pump.

According to one embodiment, the method includes the following steps:
providing a third section including a third thermal barrier connected at one of its ends to the outer jacket and at the other of its ends to the inner line, the third thermal barrier extending inside the internal space;
sealingly connecting, notably by welding, the other of the ends of the connecting section to one of the ends of the third section, notably before the step of reducing the pressure in the internal space.

### BRIEF DESCRIPTION OF THE DRAWINGS

The invention will be better understood on reading the following description and examining the accompanying figures. These figures are given only as a non-limiting illustration of the invention.

FIG. 1 is a schematic view of an embodiment of a pipe according to the invention;

FIG. 2 is a schematic view of another embodiment of a pipe according to the invention;

FIG. 3 is a schematic view of another embodiment of a pipe according to the invention; and

FIG. 4 is a schematic view of another embodiment of a pipe according to the invention.

Identical, similar or analogous elements are denoted using the same references from one figure to another.

### DETAILED DESCRIPTION OF THE PREFERRED EMBODIMENTS

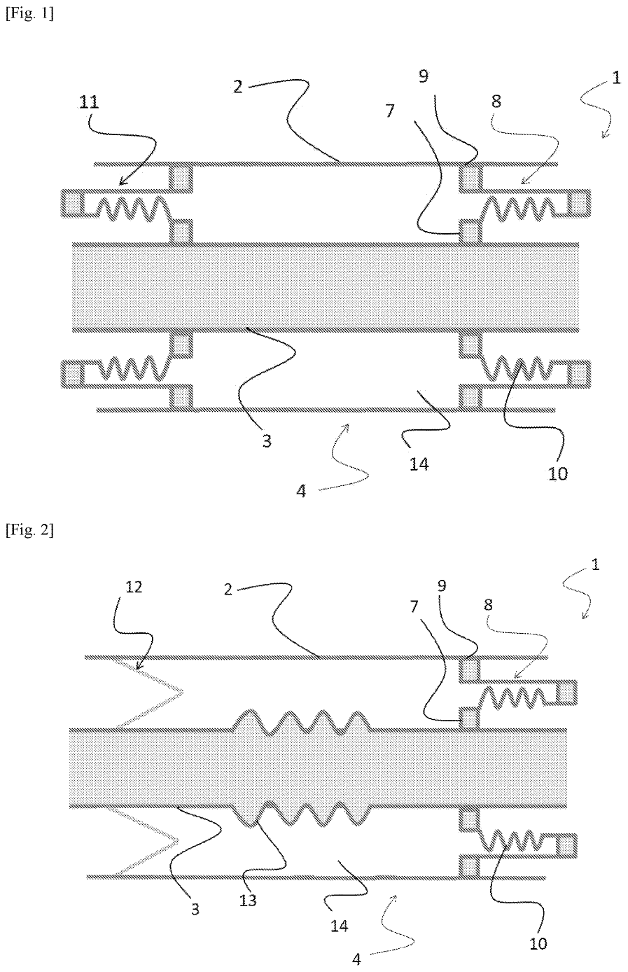

FIG. 1 shows a double-jacket pipe 1 for transferring cryogenic fluid.

The pipe 1 includes an outer jacket 2 and at least one inner line 3, the inner line 3 being configured to transfer a cryogenic fluid.

The inner line 3 extends inside the outer jacket 2, the outer jacket 2 and the inner line 3 together defining an internal space 14, 15, 16, notably an annular space, intended to be evacuated.

As shown in FIG. 1, the pipe 1 includes a first section 4 including a first thermal barrier 8.

The thermal barrier 8 is connected at one of its ends 9 to the outer jacket 2 and at the other of its ends 7 to the inner line 3.

The first thermal barrier 8 extends entirely inside the internal space 14, sealingly separating the internal space 14, 15, 16, between a first portion 14 of the internal space and a second portion 15 of the internal space, each arranged on either side of the first thermal barrier 8.

The first thermal barrier 8 does not extend inside the inner line 3.

The first thermal barrier 8 includes a first thermal compensator 10, configured to compensate for the thermal expansion and/or to compensate for the thermal contraction of the inner line 3 relative to the outer jacket 2.

The first thermal compensator 10 includes a first elastic portion 10, for example a first elastic bellows 10.

The inner line 3 is configured to allow the cryogenic fluid to flow in the inner line 3 without being in contact with the first thermal compensator 10. Thus, the inner line 3 forms an insulating partition between the first thermal compensator 10 and the cryogenic fluid.

The inner line 3 of the first section 4 includes a rigid or semi-rigid portion extending notably over the entire length of the first section 4.

The first section 4 further includes a second thermal barrier 11 extending inside the internal space 14, 15, 16 and being configured to sealingly separate the internal space.

Thus, as shown in FIG. 1, the first thermal barrier 8 and the second thermal barrier 11 are together configured to keep the first portion of the internal space 14 under vacuum after having been evacuated.

In the example shown in FIG. 1, the second thermal barrier 11 includes a second thermal compensator 11 configured to compensate for the thermal expansion/contraction of the inner line 3 relative to the outer jacket 2.

It should be noted that the inner line 3 of the pipe 1 in FIG. 1 includes a thermal line compensator (not shown in FIG. 1 because it is arranged on a section other than the first section 4), arranged on the wall of the inner line.

It is the combination of the thermal line compensator with the first thermal compensator that absorbs deformations in the piping without requiring a thermal compensator on the inner line of each section, while limiting the pressure drops in the inner line of the pipe. If there were no thermal line compensator, the section would have no way of expanding or contracting when the cryogenic fluid is flowing, and would be damaged or broken.

FIG. 2 shows a variant of the first section 4 in FIG. 1 in which:
the inner line 3 includes a thermal line compensator 13, arranged on the wall of the inner line 3; and
the second thermal barrier 12 includes a fixed barrier 12.

The fixed barrier 12 has rigid or semi-rigid walls.

In another variant of the first section 4 in FIG. 1, the inner line 3 may include the thermal line compensator 13 as shown in FIG. 2.

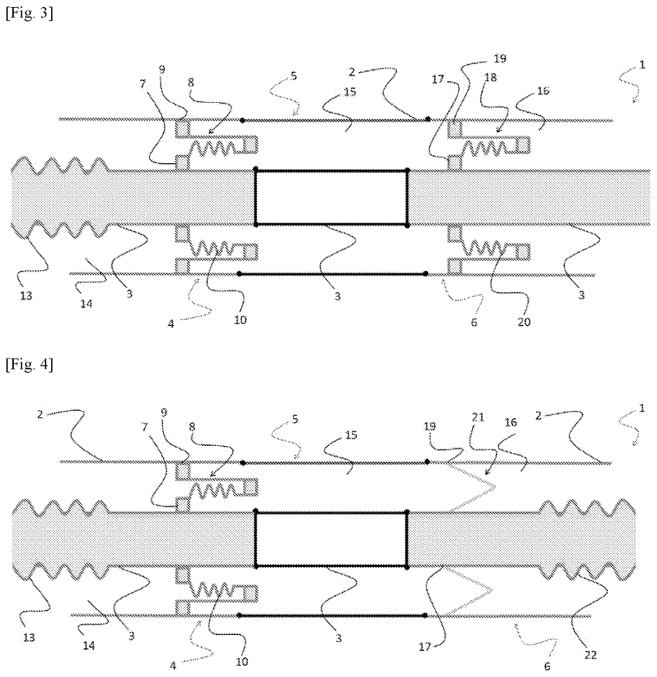

As shown in FIG. 3, the pipe 1 includes a first section 4 as described above.

The pipe 1 further includes a connecting section 5 sealingly connected to the first section 4 at one of the ends of the connecting section 5.

The pipe 1 further includes a third section 6 sealingly connected to the connecting section 5 at the other of the ends of the connecting section 5.

The connecting section 5 is connected to the first section, near to the first thermal barrier 8. More precisely, the first thermal barrier 8 extends longitudinally inside the internal space, from at least one of its ends 7, 9 toward the connecting section 5.

The connecting section 5 is connected to the first section 4 by at least one weld provided on the outer jacket 2 and on the inner line 3.

As shown in FIG. 3, the connecting section 5 is configured such that its length varies only as a result of its own thermal expansion/contraction. More precisely, the connecting section 5 has no thermal compensator on the inner line 3 or on the outer jacket 2.

The inner line 3 of the connecting section 5 forms a rigid tubular portion extending over the entire length of the connecting section 5.

The connecting section 5 includes an orifice intended to allow the pressure in the second portion 15 of the internal space 14, 15, 16 to be reduced.

The third section 6 includes a third thermal barrier 18 connected at one of its ends 19 to the outer jacket 2 and at the other of its ends 17 to the inner line 3, the third thermal barrier 18 extending inside the internal space 14, 15, 16.

In the example in FIG. 3, the third thermal barrier 18 includes a third thermal compensator 20.

The third thermal compensator 20 is configured to compensate for the thermal expansion/contraction of the inner line 3 relative to the outer jacket 2.

The third thermal compensator 20 includes a third elastic portion 20, for example a third elastic bellows 20.

In the same way as for the first section 4, the third section 6 includes a fourth thermal barrier (not shown in FIG. 3) connected at one of its ends to the outer jacket 2 and at the other of its ends to the inner line 3, the fourth thermal barrier extending inside the internal space.

The fourth thermal barrier is configured to sealingly separate the internal space 14, 15, 16 between the third portion of the internal space 16 and a fifth portion of the internal space, each arranged on either side of the fourth thermal barrier.

The pipe 1 thus includes an assembly of:
a first section 4 forming a first portion 14 of the internal space 14, 15, 16, this first portion 14 being intended to be evacuated during the manufacture of the first section and being intended to be kept under vacuum by the first thermal barrier 8 and the second thermal barrier 11;
a third section 6 forming a third portion 16 of the internal space 14, 15, 16, this third portion 16 being intended to be evacuated during the manufacture of the third section 6 and being intended to be kept under vacuum by the third thermal barrier 18 and the fourth thermal barrier; and
a connecting section 5 forming a third portion 15 of the internal space 14, 15, 16, this third portion 15 being intended to be evacuated when the connecting section 5 is assembled with the first section 4 and with the third section 6.

FIG. 4 shows a pipe 1 of the same type as shown in FIG. 3, in which:
the third section 6 includes a second thermal line compensator 22, arranged on the wall of the inner line 3;
the third thermal barrier 19 includes a second fixed barrier 19, including notably rigid or semi-rigid walls but no thermal compensator.

A method for assembling a pipe as described above includes the following steps:
sealingly connecting, notably by welding, one of the ends of the connecting section 5 to one of the ends of the first section 4;
sealingly connecting, notably by welding, the other of the ends of the connecting section 5 to one of the ends of the third section 6;
reducing the pressure in the second portion 15 of the internal space 14, 15, 16 by connecting the orifice of the connecting section 5 to a vacuum pump.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-9. (canceled)

10. A double-jacket pipe for transferring cryogenic fluid, comprising an outer jacket and at least one inner line configured to transfer the cryogenic fluid, the inner line extending inside the outer jacket, the outer jacket and the inner line together defining an internal annular space configured to be evacuated, the pipe including a first section including a first thermal barrier connected at a first end to the outer jacket and at a second end to the inner line, the first thermal barrier extending inside the internal space,
wherein the first thermal barrier includes a first thermal compensator configured to compensate for the thermal expansion/contraction of the inner line relative to the outer jacket, the inner line including a thermal line compensator arranged on the wall of the inner line.

11. The double-jacketed pipe as claimed in claim 10, wherein the first thermal compensator comprises a first elastic portion.

12. The double-jacketed pipe as claimed in claim 10, wherein the inner line is configured to allow the cryogenic fluid to flow in the inner line without being in contact with the first thermal compensator.

13. The double-jacketed pipe as claimed in claim 10, wherein the first section comprises a second thermal barrier extending inside the internal space.

14. The double-jacketed pipe as claimed in claim 10, further comprising a connecting section sealingly connected to the first section at one of the ends of the connecting section.

15. The double-jacketed pipe as claimed in claim 14, further comprising a third section sealingly connected to the connecting section at the other of the ends of the connecting section, the third section including a third thermal barrier connected at one of the ends to the outer jacket and at the other end to the inner line, the third thermal barrier extending inside the internal space.

16. The double-jacketed pipe as claimed in claim 15, wherein the third thermal barrier comprises a third thermal compensator.

17. A method for assembling a double-jacket pipe for the transfer of cryogenic fluid, including the steps of:
providing an outer jacket and at least one inner line configured to transfer the cryogenic fluid, the inner line extending inside the outer jacket, the outer jacket and the inner line together defining an annular internal space, configured to be evacuated, the pipe including a first section including a first thermal barrier connected at one of the ends to the outer jacket and at the other end to the inner line, the first thermal barrier extending inside the internal space, the first thermal barrier includes a first thermal compensator configured to compensate for the thermal expansion/contraction of the inner line relative to the outer jacket;
providing a connecting section including an orifice intended to allow the pressure in the internal space to be reduced;
sealingly connecting by welding, one of the ends of the connecting section to one of the ends of the first section;
reducing the pressure in the internal space by connecting the orifice to a vacuum pump.

18. The method as claimed in claim 17, further comprising the steps of:
providing a third section including a third thermal barrier connected at one of the ends to the outer jacket and at the other end to the inner line, the third thermal barrier extending inside the internal space;
sealingly connecting by welding, the other of the ends of the connecting section to one of the ends of the third section before the step of reducing the pressure in the internal space.
